(19) United States
(12) Patent Application Publication
(10) Pub. No.: US 2020/0380444 A1
(43) Pub. Date: Dec. 3, 2020

(54) Determining Collaborative Enterprise Decisions Based on Regulatory Impacts

(71) Applicant: International Business Machines Corporation, Armonk, NY (US)

(72) Inventors: Aswin Kannan, Chennai (IN); Arun Kumar, New Delhi (IN); Leo Kluger, Armonk, NY (US)

(21) Appl. No.: 16/425,372

(22) Filed: May 29, 2019

(51) Int. Cl. G06Q 10/06; G06N 20/00; G06N 7/00; G06F 17/27

(52) U.S. Cl. CPC G06Q 10/06375; G06Q 10/06393; G06F 17/27; G06N 20/00; G06N 7/005; G06Q 10/067

(57) ABSTRACT

Methods, systems, and computer program products for determining collaborative enterprise decisions based on regulatory impacts are provided herein. A computer-implemented method includes generating, for each one of multiple target entities within an enterprise, impact functions pertaining to entity-specific impacts of a regulation on one or more impact factors; producing weighted impact functions by applying, to the generated impact functions, weights determined by the multiple target entities; calculating a combined enterprise impact attributed to the regulation by combining the weighted impact functions via one or more algorithms; determining a single collaborative enterprise policy for complying with the regulation based at least in part on the combined enterprise impact; and outputting the collaborative enterprise policy to the multiple target entities within the enterprise.

### FIELD

The present application generally relates to information technology and, more particularly, to compliance and management techniques.

### BACKGROUND

Across many companies, businesses, and other such enterprises, regulatory environments vary and change, resulting in direct and indirect impacts on such enterprises. In response, enterprises commonly need to come up with one optimal process to remain compliant. However, such enterprises can encompass multiple agents within multiple groups or departments, each having different viewpoints on regulatory impacts and enterprise-related goals. Accordingly, reaching and/or determining one optimal compliance process for an entire enterprise results in challenges.

### SUMMARY

In one embodiment of the present invention, techniques for determining collaborative enterprise decisions based on regulatory impacts are provided. An exemplary computer-implemented method includes generating, for each one of multiple target entities within an enterprise, one or more impact functions pertaining to entity-specific impacts of at least one regulation on one or more impact factors. The method also includes producing weighted impact functions by applying, to the generated impact functions, weights determined by the multiple target entities. Additionally, the method includes calculating a combined enterprise impact attributed to the at least one regulation by combining the weighted impact functions via one or more algorithms, and determining a single collaborative enterprise policy for complying with the at least one regulation based at least in part on the combined enterprise impact. Further, the method includes outputting the collaborative enterprise policy to the multiple target entities within the enterprise.

Another embodiment of the invention or elements thereof can be implemented in the form of a computer program product tangibly embodying computer readable instructions which, when implemented, cause a computer to carry out a plurality of method steps, as described herein. Furthermore, another embodiment of the invention or elements thereof can be implemented in the form of a system including a memory and at least one processor that is coupled to the memory and configured to perform noted method steps. Yet further, another embodiment of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating system architecture, according to an exemplary embodiment of the invention;

FIG. 2 is a diagram illustrating an algorithm for determining collaborative enterprise decisions based on regulatory impacts, according to an exemplary embodiment of the invention;

FIG. 3 is a diagram illustrating a workflow for determining collaborative enterprise decisions based on regulatory impacts, according to an exemplary embodiment of the invention;

FIG. 4 is a diagram illustrating an example enterprise impact representation, according to an exemplary embodiment of the invention;

FIG. 5 is a diagram illustrating an example determination of combined impact across multiple enterprise factors, according to an exemplary embodiment of the invention;

FIG. 6 is a diagram illustrating text analysis utilized in determining collaborative enterprise decisions based on regulatory impacts, according to an exemplary embodiment of the invention;

FIG. 7 is a flow diagram illustrating techniques according to an embodiment of the invention;

FIG. 8 is a system diagram of an exemplary computer system on which at least one embodiment of the invention can be implemented;

FIG. 9 depicts a cloud computing environment according to an embodiment of the present invention; and

FIG. 10 depicts abstraction model layers according to an embodiment of the present invention.

### DETAILED DESCRIPTION

As described herein, an embodiment of the present invention includes collaborative analysis of regulatory business impact. At least one embodiment includes taking inputs from multiple individual stakeholders (i.e., agents) on feasible options and the corresponding perceived quantification of respective impacts on an enterprise to determine a unified decision (consensus).

As such, one or more embodiments include estimating impact functions using historical data to assign weights (to certain historical data) based on one or more iterative analyses to assist agents in connection with enterprise decisions related to financial and non-financial impacts resulting from one or more regulations. Additionally, such an embodiment also includes operating independently to yield one or more feasible solutions by taking input comprising a corpus of historic transaction data, evolving regulatory enterprise decision data, compliance-related impact functions, and agent weights.

Accordingly, agents iteratively and consecutively learn one or more relevant impact functions, enterprise decisions, and weights related thereto for financial and non-financial portions of regulatory impact. As noted, impact functions are estimated from historical data, and weights are learnt from an iterative analysis of the impact functions. Additionally, as further detailed herein, enterprise decisions are obtained (and can evolve over time) iteratively via application of the impact functions and weights by a consensus-based approach. Also, one or more portions of such an embodiment include solving a nonlinear optimization and/or a natural language problem.

Given a specific geographical location, one or more decision variables utilized in determining a collaborative consensus enterprise decision can include the following. For example, such decision variables can include the number of data transfer centers required for one or more tasks, the maximum volume of data that can be transferred, the presence or absence of cloud-based processing, the number of individuals (e.g., employees) and their shifts deployed to finish one or more tasks, the role (or responsibility) assignment to each individual, the total number of individuals handling certain portions of data, the locational presence (e.g., coordinates) of the individual handling a certain portion of data at a certain time, a cap on profit margins, etc. In one or more embodiments, all such decision variables are divided into different categories such as financial variables, workforce (roles and responsibilities) variables, operations (e.g., data storage and/or transfer) variables, and strategy (e.g., partnerships, ventures, profit margins, cost-sharing, etc.) variables.

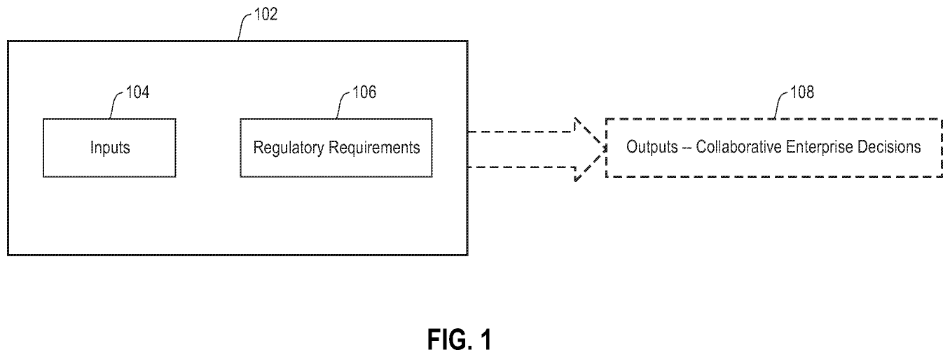

FIG. 1 is a diagram illustrating system architecture, according to an embodiment of the invention. By way of illustration, FIG. 1 depicts a collaborative consensus determination system 102, which processes inputs 104 and regulatory requirements 106 to generate one or more outputs 108 in the form of collaborative enterprise decisions. Such inputs 104 can include, for example, enterprise/business settings, tunable impact factors, and tunable decision entities. Business settings can include financial variables, workforce variables, operations variables, strategy variables, etc. Tunable impact factors (which can include weights) can include factors such as revenue, options (e.g., stake), quality, customer satisfaction, employee satisfaction, business efficiency, etc. Tunable decision entities can include, for example, auditors, finance entities, operations entities, security entities, sales entities, legal entities, etc. Additionally, one or more embodiments can include tunable sources for such input, wherein such sources include government regulations, internal enterprise policy documents, financial agency data, news articles, public and/or customer feedback, etc.

Finance-related input data can include, for example, balance sheets and loss information related to regulatory violations. An impact function for such data can be built on accounting, revenue, and cost-related data. Security-related data can include, for example, which individuals perform which tasks, as well as data pertaining to one or more information flows, breaches, suspicious behavior, and/or policy violations. An impact function for such data can include, for instance, a consequence of previous security breaches and business architectural changes. Additionally, sales-related data can include, for example, product aspects and/or attributes, win-loss information pertaining to clients, and client information (e.g., demographics). An impact function for such data can include, for instance, a consequence of the percentage of deals won and clients' positioning with respect to product attributes and policies.

As also noted in FIG. 1, the regulatory requirements 106 can include, for example, security-related requirements, data-related requirements, transfer-related requirements, portability-related requirements, usability-related requirements, feasibility-related requirements, and/or component design-related requirements.

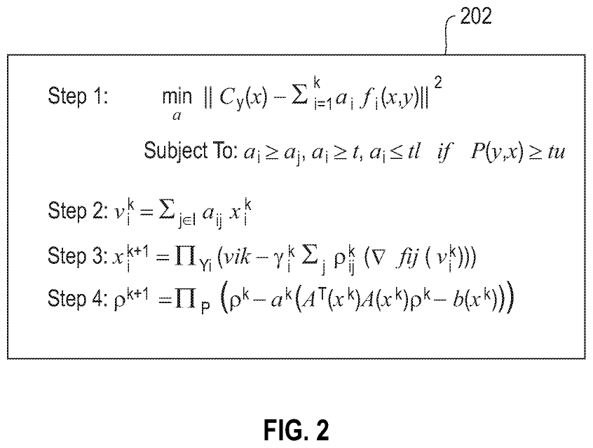

FIG. 2 is a diagram illustrating an algorithm 202 for determining collaborative enterprise decisions based on regulatory impacts, according to an exemplary embodiment of the invention. As depicted, in step 1 of algorithm 202, given training data (xᵢ, fᵢ), the algorithm 202 estimates a collective impact from a tailored model. Step 2 includes agent communication and iterating averaging (using predetermined weights). Step 3 includes taking a step towards solving the enterprise optimization objective, and step 4 includes updating weights and/or conceived notions. Additionally, in one or more embodiments, algorithm 202 returns to step 1 until a convergence is reached. Note that step 1 entails solving a regression problem to obtain impact functional parameters, while step 2 includes a sum operation, and steps 3 and 4 correspond to projection and quadratic optimization problems.

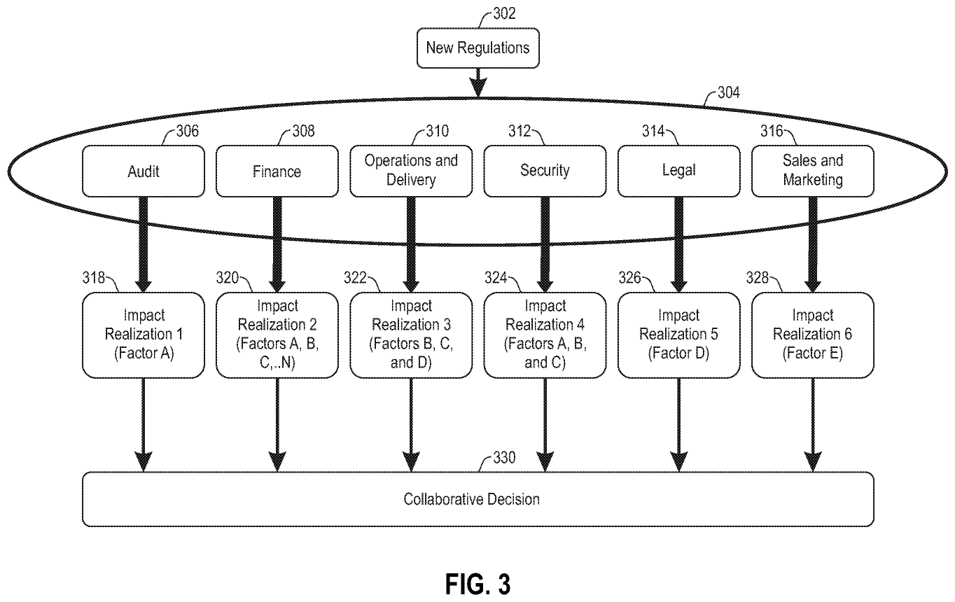

FIG. 3 is a diagram illustrating a workflow for determining collaborative enterprise decisions based on regulatory impacts, according to an exemplary embodiment of the invention. By way of illustration, FIG. 3 depicts new regulations 302, which affect a set of variables 304 that include an audit variable 306, a finance variable 308, an operations and delivery variable 310, a security variable 312, a legal variable 314, and a sales and marketing variable 316. The new regulation-induced effects on the noted variables result in respective impact realizations 318, 320, 322, 324, 326, and 328. These impact realizations are then utilized to generate and/or determine a collaborative decision 330 pertaining to the new regulations 302. With respect to impact realizations, consider the following examples.

### Example 1

Assume a new and/or introductory regulation pertaining to the transfer of data, and the regulation demands that data cannot be transferred or routed through specific countries, say A and B. However, in reality, such a routing is practically necessary. The legal, operations, and security teams would aim at achieving the same using a cloud-based resource at a third location at a cost of 2× (that is, twice the original). The sales, finance, and auditing teams may merely ignore such transfers and simply prune the related clients from their businesses.

### Example 2

Assume a new regulation is imposed such that it limits the maximum movable storage capacity of personal and/or identity-related data of all clients of an organization (say, 100 terabytes). This may be viewed as using immovable hard drives (or tape drives) by the audit, finance, and operations teams for most of the storage and, say, less than ten percent with external universal serial bus (USB) drives. In this way, there would not be any cap on storage. However, this may be viewed as less mobile by the sales and marketing team, which may, in turn, suggest using external cloud and removable USB drives (e.g., for more than 90 percent of the total storage) at a comparatively higher cost. The legal and security teams, on the other hand, may completely refrain from using any external devices, owing to breach-related complications. Such actions can translate to drastically different impact functionals.

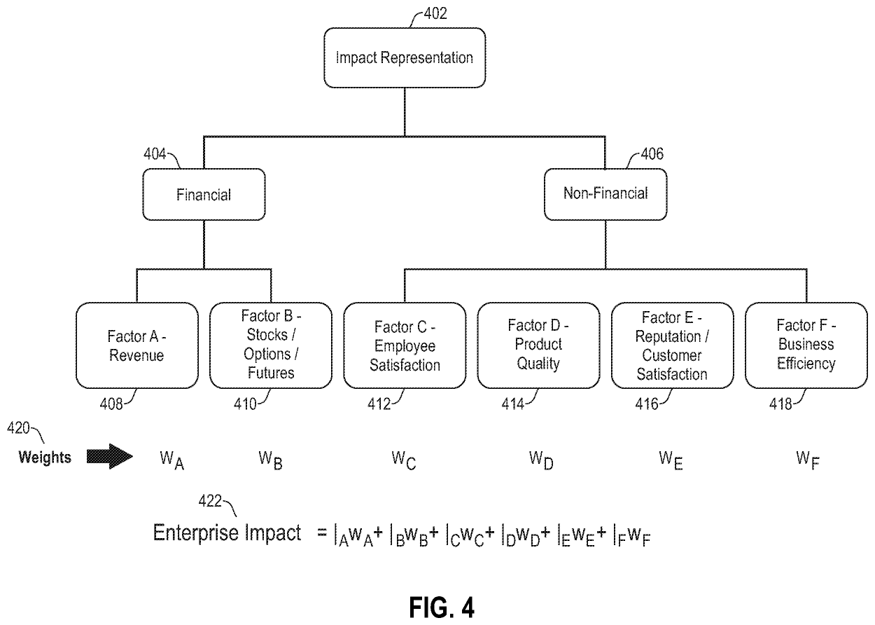

FIG. 4 is a diagram illustrating an example enterprise impact representation, according to an exemplary embodiment of the invention. By way of illustration, FIG. 4 depicts impact representation 402, which is divided into financial impact 404 and non-financial impact 406. Additionally, the financial impact 404 is divided into a first factor (Factor A) 408 related to revenue and a second factor (Factor B) 410 related to stocks, options, futures, etc. Similarly, the non-financial impact 406 is divided into multiple factors, including Factor C 412 related to employee satisfaction, Factor D 414 related to product quality, Factor E 416 related to reputation and/or customer satisfaction, and Factor F 418 related to business efficiency. Respective weights 420 are applied to the various factors, and based thereon, an enterprise impact 422 is determined by combining the weighted impact factors.

In equating financial and non-financial impacts, one or more embodiments include representing financial impacts (e.g., revenue, stocks, etc.) in terms of monetary values (such as dollars). Similarly, such an embodiment also includes attributing a monetary value (e.g., dollars) to non-financial portions of impact as well. Examples of non-financial impacts can include regulatory impacts on employee satisfaction, customer satisfaction, and business efficiency (related to security, for instance). By way of illustration, an impact on business efficiency can pertain to the number of products and/or components produced in a manufacturing enterprise. Another non-financial impact can include regulatory impact on product quality. For example, such an impact can be provided by step and/or non-smooth functions of the form: Impact (IP)=−p*max(Aₑ−A_{c},0), wherein p is the weighing factor (for dollar scaling), while Aₑ and A_{c} correspond to expected and current/attained levels of accuracy, respectively.

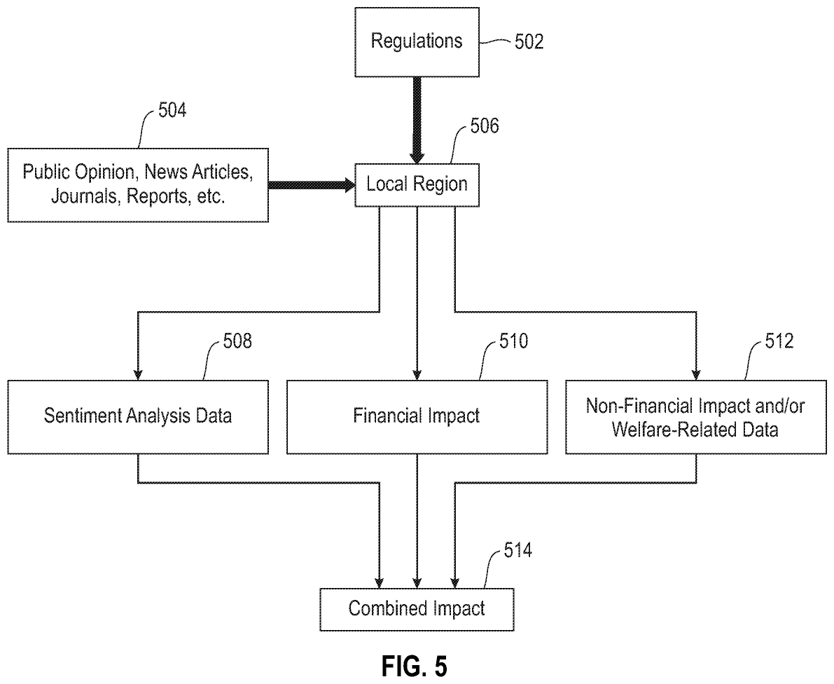

FIG. 5 is a diagram illustrating an example determination of combined impact across multiple enterprise factors, according to an exemplary embodiment of the invention. By way of illustration, FIG. 5 depicts regulations 502 and input data 504 (such as public opinion information, new articles, journals, reports, etc.) directed to a given local region 506. Information pertaining to and/or derived from the regulations 502, the input data 504, and the local region 506 is then provided to and utilized by a sentiment analysis data component 508, a financial impact component 510, and a non-financial impact and/or welfare-related data component 512. Outputs from components 508, 510 and 512 are then combined to generate and/or determine a combined impact 514 of the regulations 502.

The sentiment analysis data component 508 includes making one or more binary (positive/negative) determinations based on the provided information, and also includes applying one or more multi-class labels to portions of the provided information. With respect to the multi-class labels, say, for example, that a government entity frames a regulation stating minimal and maximal caps on electricity sharing between states. An example multi-class sentiment label can be stated as follows: [‘excellent,’ ‘good,’ ‘optimal,’ ‘reasonable,’ ‘sub-optimal,’ ‘bad’]. These can also be represented by appropriate numbers. The financial impact component 510 includes making determinations based on parameters such as historical costs and/or losses of change due to regulatory adoption, as well as relevant surplus or profit-related data of subjects, individuals, and organizations within the enterprise. The non-financial impact and/or welfare-related data component 512 includes processing security-related information (e.g., history of threats and identification thefts) as well as historical society-related growth indicators (e.g., gross domestic product (GDP), life expectancy, industry penetration, technology adaptation, healthcare information, etc.).

In one or more embodiments, generating and/or determining combined impact 514 can include implementing one or more neural models, such as, for example, the following: ƒᵢ(xᵢ)=Σ_{k∈K}wᵢₖƒᵢₖ(xi). In such an example, note that “xᵢ” represents the set of decision variables of agent i. Additionally, in such an example, ƒᵢ(x) defines the negative impact of agent i, and xᵢ denotes the set of constraints for agent i. Agent i's problem can be defined, in one or more embodiments, as follows:

$${min}_{{x}_{i}} fi ( xi ) ,$$

subject to: xᵢ ∈xᵢ. Note that the individual functions ƒᵢ(x) are a weighted sum of the impact given by financial and non-financial components. Additionally, note that k corresponds to financial components (e.g., revenue) and non-financial components (e.g., product quality). Also, if certain components are absent, set the corresponding value of the ƒᵢₖ component can be set to 0. Further, note that w refers to the weights (nonnegative).

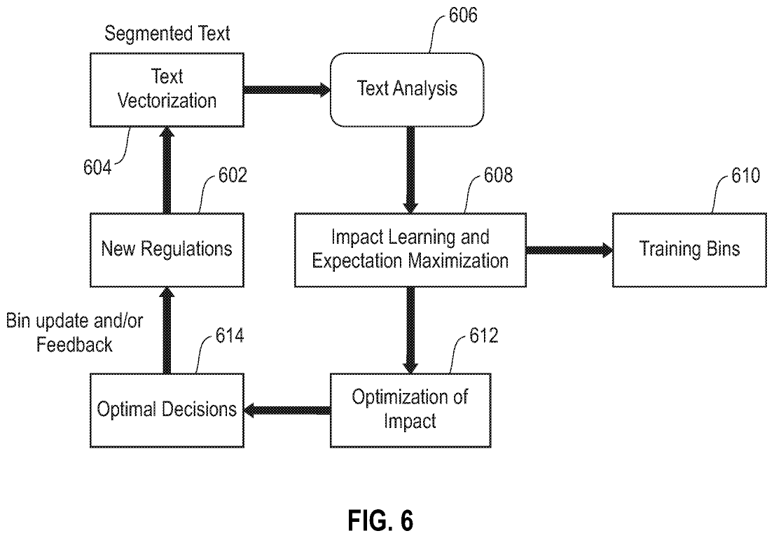

FIG. 6 is a diagram illustrating text analysis utilized in determining collaborative enterprise decisions based on regulatory impacts, according to an exemplary embodiment of the invention. By way of illustration, FIG. 6 depicts new regulations 602, which are provided to a text vectorization component 604, whereby segmented text is generated and provided to a text analysis component 606. The text analysis component 606 provides an output to an impact learning and expectation maximization component 608, which subsequently provides outputs to training bins 610 and impact optimization component 612. An output from the impact optimization component 612 is utilized to generate one or more optimal decisions 614, which can provide bin updates and/or feedback directed to the new regulations 602. In one or more embodiments, the text vectorization component 604 and the text analysis component 606 correspond to natural language segments that translate and/or transform textual data into numerical values based on predefined dictionaries and context spaces. Also, in such an embodiment, the impact learning and expectation maximization component 608, impact optimization component 612, and optimal decisions 614 correspond to the optimization framework in its entirety, and training bins 610 provide a way to assort training data into multiple bins (e.g., transformation into categories).

The impact learning and expectation maximization component 608 can include implementing techniques such as random fields, support vector machines (SVMs), naïve Bayes, and/or deep learning. Additionally, the impact optimization component 612 can include implementing techniques such as gradient descent and/or augmented Lagrangian approaches, consensus functionals; integration of stochastic error, etc.

Also, as detailed herein, at least one embodiment includes learning various impact functions, for example, via text analysis component 606. In such an embodiment, a text-based set of inputs, which can include documented government regulations, internal enterprise policy documents, customer reviews, news articles, etc., is processed by the text analysis component 606. Such text inputs can also include portions of unstructured data. Processing by the text analysis component 606 can include highlighting components of the input text specific to each of one or more enterprise groups/units. Additionally, each aspect of the text is given a numerical weight that is dependent on the context of analysis (pertaining to a specific enterprise group/unit).

Subsequently, a classification method, which can include a naïve Bayes approach or an SVM approach, is deployed, depending on the points available in the data set (e.g., the number). One or more embodiments additionally include binning these data pertaining to different factors (e.g., revenue, product quality, customer satisfaction, etc.), which is carried out based on the classification and expectation minimization.

Further, at least one embodiment includes mapping text to labels. Such an embodiment includes using Gibbs-based random field models to estimate inter-textual relationships. For example, consider the word “breach.” A security professional may relate a “breach” to reputation, whereas a financial engineer may look at binning such data towards penalties. On the other hand, an auditor may relate such data to a customer satisfaction bin.

One or more embodiments additionally include calculating one or more frequency estimations. Such an embodiment can include utilizing training data {xᵢ, yᵢ}, i={1, . . . N}, wherein x denotes words appearing in text and y refers to the corresponding labels. Additionally, states can be denoted by j={1, . . . , n}. States refer to time-periods or states of a Markovian chain, and are inherently part of the model. A model implemented by such an embodiment can include the following:

$${p}_{y} ( x , y ) = \frac{{C}_{y (} x , y )}{{\prod }_{y = 1}^{n + 1} {C}_{y} ( x , y )} , {C}_{y} ( x ) {\sum }_{i = 1}^{k} {α}_{i} {f}_{i} ( x , y ) .$$

In such an embodiment, parametrization in alpha can be estimated based on data, and functions “fᵢ(.,.)” can be exponential, logarithmic, and/or polynomial.

Additionally, one or more embodiments include determining model constraints and discarding one or more points. In such an embodiment, it is noted that certain impact functions are more important than others, certain coefficients have to be greater than a given threshold, and irrelevant outliers can be discarded. Such an embodiment further includes solving a regression problem that can be detailed as follows:

$${min}_{α} ‖ Cy ( x ) - {\sum }_{i = 1}^{k} α ifi ( x , y ) ‖ 2 , subject to α i \geq α j , α i \geq t , α i \leq tl .$$

if P(y,x)≥tu. Additionally, such an embodiment also includes handling binary and discrete variables via as follows:

$${min}_{α x} ‖ Cy ( x , α x ) - Cy ( x , α x ) ‖ 2 ,$$

subject to: αi ∈ {0,1}, αj ∈ {α1, . . . am}, for i ∈I, j ∈J.

At least one embodiment includes determining a distributed weighting consensus. Such an embodiment includes attempting to unify the impact(s) of all agents into a single objective by means of non-negative weights (represented by rho). Note that such an embodiment can include a common set of decision variables x in this formulation: ƒ(x)=Σ_{i∈I}ρᵢƒᵢ(x). Additionally, such an embodiment includes unifying the strategy sets by using the intersection operation as follows: Yᵢ=Rn ∩ Xᵢ, X=∩ᵢYᵢ.

In furtherance of such an embodiment, an averaging is determined over agent iterates: vik=Σ_{j∈I}αijxik, Σ_{j∈I}αij=1. Note that ‘a’ here refers to weights and is assumed to follow certain specification rules. Also, one or more embodiments include implementing a distributed projected gradient scheme as follows: xᵢ^{k+1}=ΠYi(vik−γik ρik ∇ ƒi(vik)). Note that pi represents a projection operation and is given by solving the following quadratic/nonlinear optimization problem:

$$z = {Π}_{z} ( y ) \to {min}_{z} ‖ z - y ‖ 2 ,$$

subject to: z ∈ Z. Note also that v refers to the consensus portion, and by asymptotics, when k→∞, then vik=vk=xᵢ^{k}=xk for all i.

Additionally, let ρ* denote the optimal set of weights which exactly quantify the impact of the regulation(s). Note that this value is not known a priori, and it is a result of consensus amongst agents. Alternatively, flexibility can be given to the system to choose one or more weights such that the problem reduces to the following: minx ƒ(x)=Σ_{i∈I}Σ_{ρ∈K}ρiρƒiρ(x), subject to x ∈ X.

In the absence of consensus in enterprise decisions x, a model can be implemented to predict functions f(·) such that ƒi(xᵢ*)≈ƒj(xⱼ*), j≠i, ∀i, j ∈ I. Alternatively, in the presence of consensus, ƒi(x*)≈ƒj(x*), j≠i, ∀i, j ∈ I. This finally reduces to the specification of rho (ρ), which equivalently reduces to solving the following minimization problem: min ρ g(ρ)=Σ_{i∈I}Σ_{j≠i,j∈I}(Σ_{r∈K} ρiρƒiρ(x*)−Σ_{Σ∈K}ρjρƒjρ(x*))² subject to ρ ∈ P.

The above-noted rho problem is dependent on the specification of ƒ(·) as well as the decision variables x. Note that constraints can exist on ρ, and these are given by the set P (some examples include non-negativity and summing to 1). Motivated by the fact that the iterates x^{k} will converge to a limit point x¹, at least one embodiment includes attempting to determine a scheme wherein ρ^{k+1}=argmin g(ρ, xk). Note that the function g(·) is quadratic in rho. For ease of notation, the same can be represented as follows: g(ρ)=½∥A(x^{k})ρ−b(x^{k})∥². Note also that A(x^{k}) and b(x^{k}) are defined based on ƒ(x^{k}).

Accordingly, such an embodiment can be summarized in the following three steps: First, averaging over agent decisions (moving towards agents' consensus): vik=Σ_{j∈I}αijxik; Second, carrying out the agent's projection step (moving towards the consensus enterprise decision): xᵢ^{k+1}=Π_{Yi}(vik−γik Σᵢρᵢⱼ^{k} (∇ƒij(vik))); and Third, updating weights (moving towards the correct impact function): ρ^{k+1}=Π_{P}(ρ^{k}−αk(AT(xk)A(xk)ρ^{k}−b(xk))). Note that, in such an embodiment, the a values need to sum up to one for each agent.

Additionally, at least one embodiment includes addressing non-linearity. In practice, the agent strategy sets Xi are characterized by the presence of highly non-linear and sometimes non-convex constraints. Accordingly, one or more embodiments include presenting a penalization and/or augmented Lagrangian layer as follows:

$${min}_{xi} fi ( xi )$$

$$[ Subject to \text{:} {x}_{i} ∈ {X}_{i} ] \to {min}_{xi} fi ( xi ) + λ Thi ( xi ) + 0.5 μ ‖ hi ( xi ) ‖ 2 [ Subject to \text{:} {x}_{i} ∈ {S}_{i} ] ,$$

wherein Xᵢ={xᵢ|xᵢ in Sᵢ, hᵢ(xᵢ)=0}.

An alteration to at least a portion of a method previously described herein is as follows:

xᵢ^{k+1}=Π_{Yi}(vik−γik(Σⱼρᵢⱼ^{k}(∇ƒij(vᵢ^{k}))+λ∇hi(vik)+μhi(vik)∇hi(vik));

λᵢ^{k+1}=λᵢ^{k}+βik hi(vik); and

μᵢ^{k+1}=2μᵢ^{k}.

Note that such a method can incorporate inequality constraints along with the incorporation of appropriate slack variables. Also, the choice of updating ‘mu’ is variable, and the multiplicative factor can be any number greater than one and not necessarily equal to two.

Further, at least one embodiment includes updating impact functions. As noted herein, the structure of impact functions is derived from historical data and natural language methods. However, in one or more embodiments, the exact functions need not be derived, and the process can be iterative. In such an embodiment, an optimization method uses one or more coarse approximations, which finally converges to an exact specification as follows: xᵢ^{k+1}=ΠYi (vik−γik ρᵢⱼ^{l}(∇ [symbol] (vᵢ^{k})+λ∇ [symbol] (vik)+μ [symbol] (vik)∇ [symbol] (vik)), as k→∞, [symbol] →ƒ and [symbol] →h. In one or more embodiments, as k exceeds a given threshold, closeness to the exact specification follows.

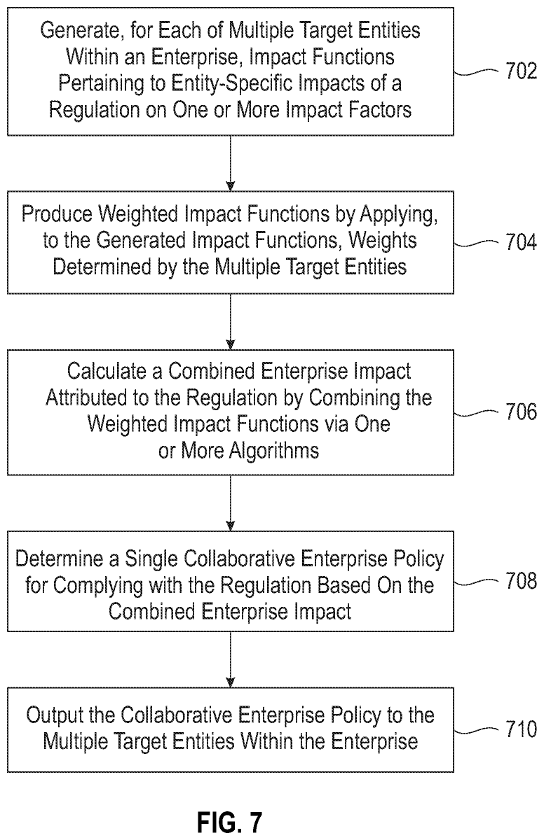

FIG. 7 is a flow diagram illustrating techniques according to an embodiment of the present invention. Step 702 includes generating, for each one of multiple target entities within an enterprise, one or more impact functions pertaining to entity-specific impacts of at least one regulation on one or more impact factors. Generating the impact functions can include iteratively estimating one or more impact functions using one or more Gibbs random fields, implementing one or more natural language processing techniques, implementing one or more support vector machines, implementing one or more naïve Bayes classifiers, and/or implementing one or more deep learning techniques. Also, the one or more impact factors can include one or more financial impact factors and/or one or more non-financial impact factors.

Further, in one or more embodiments, the multiple target entities can include one or more audit-related entities, one or more finance-related entities, one or more operations-related entities, one or more security-related entities, one or more legal-related entities, and/or one or more sales and marketing-related entities.

Step 704 includes producing weighted impact functions by applying, to the generated impact functions, weights determined by the multiple target entities. In at least one embodiment, the weights are determined by the multiple target entities via iteratively estimating one or more weights using one or more Gibbs random fields.

Step 706 includes calculating a combined enterprise impact attributed to the at least one regulation by combining the weighted impact functions via one or more algorithms. Step 708 includes determining a single collaborative enterprise policy for complying with the at least one regulation based at least in part on the combined enterprise impact. In one or more embodiments, determining a single collaborative enterprise policy includes carrying out multiple iterations of Step 702, Step 704, and Step 706.

Step 710 includes outputting the collaborative enterprise policy to the multiple target entities within the enterprise.

Additionally, at least one embodiment includes generating, for each one of multiple substantive departments within an enterprise, one or more impact functions pertaining to (i) one or more financial impact factors in connection with at least one regulation and (ii) one or more non-financial impact factors in connection with the at least one regulation. Such an embodiment also includes producing weighted impact functions by applying, to the generated impact functions, weights determined by the multiple substantive departments within the enterprise, and calculating a combined enterprise impact attributed to the at least one regulation by combining the weighted impact functions via implementing one or more neural models. Further, such an embodiment includes determining a single collaborative enterprise policy for complying with the at least one regulation based at least in part on the combined enterprise impact, outputting the collaborative enterprise policy to the multiple substantive departments within the enterprise, and updating the weighted impact functions based at least in part on feedback related to the collaborative enterprise policy from one or more of the multiple substantive departments within the enterprise.

The techniques depicted in FIG. 7 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an embodiment of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 7 can be implemented via a computer program product that can include computer useable program code that is stored in a computer readable storage medium in a data processing system, and wherein the computer useable program code was downloaded over a network from a remote data processing system. Also, in an embodiment of the invention, the computer program product can include computer useable program code that is stored in a computer readable storage medium in a server data processing system, and wherein the computer useable program code is downloaded over a network to a remote data processing system for use in a computer readable storage medium with the remote system.

An embodiment of the invention or elements thereof can be implemented in the form of an apparatus including a memory and at least one processor that is coupled to the memory and configured to perform exemplary method steps.

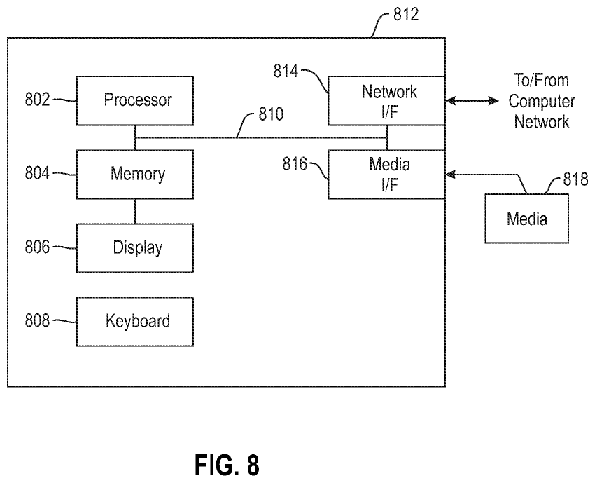

Additionally, an embodiment of the present invention can make use of software running on a computer or workstation. With reference to FIG. 8, such an implementation might employ, for example, a processor 802, a memory 804, and an input/output interface formed, for example, by a display 806 and a keyboard 808. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 802, memory 804, and input/output interface such as display 806 and keyboard 808 can be interconnected, for example, via bus 810 as part of a data processing unit 812. Suitable interconnections, for example via bus 810, can also be provided to a network interface 814, such as a network card, which can be provided to interface with a computer network, and to a media interface 816, such as a diskette or CD-ROM drive, which can be provided to interface with media 818.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 802 coupled directly or indirectly to memory elements 804 through a system bus 810. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including, but not limited to, keyboards 808, displays 806, pointing devices, and the like) can be coupled to the system either directly (such as via bus 810) or through intervening I/O controllers (omitted for clarity).

Network adapters such as network interface 814 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 812 as shown in FIG. 8) running a server program. It will be understood that such a physical server may or may not include a display and keyboard.

The present invention may be a system, a method, and/or a computer program product at any possible technical detail level of integration. The computer program product may include a computer readable storage medium (or media) having computer readable program instructions thereon for causing a processor to carry out embodiments of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform embodiments of the present invention.

Embodiments of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 802. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed digital computer with associated memory, and the like. Given the teachings of the invention provided herein, one of ordinary skill in the related art will be able to contemplate other implementations of the components of the invention.

Additionally, it is understood in advance that implementation of the teachings recited herein are not limited to a particular computing environment. Rather, embodiments of the present invention are capable of being implemented in conjunction with any type of computing environment now known or later developed.

For example, cloud computing is a model of service delivery for enabling convenient, on-demand network access to a shared pool of configurable computing resources (for example, networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (for example, country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (for example, storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (for example, web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (for example, host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (for example, mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (for example, cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

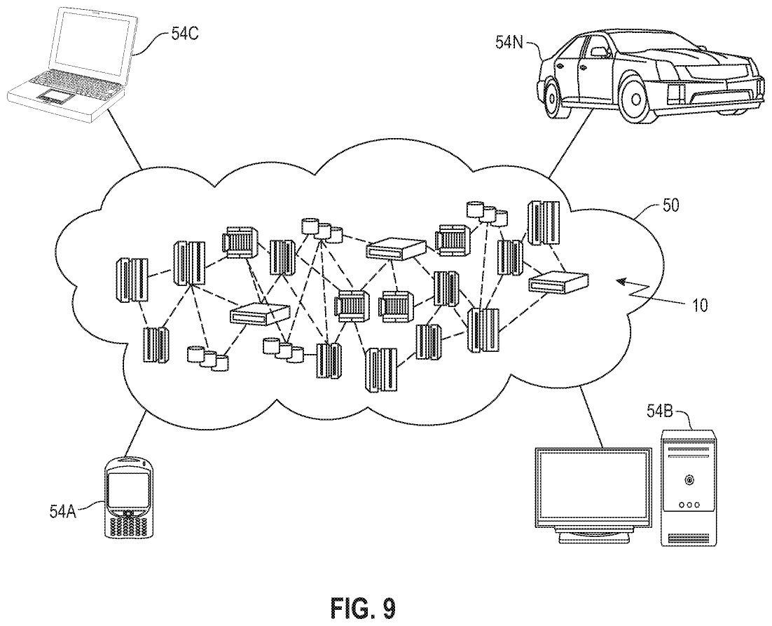

Referring now to FIG. 9, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 9 are intended to be illustrative only and that computing nodes 10 and cloud computing environment 50 can communicate with any type of computerized device over any type of network and/or network addressable connection (e.g., using a web browser).

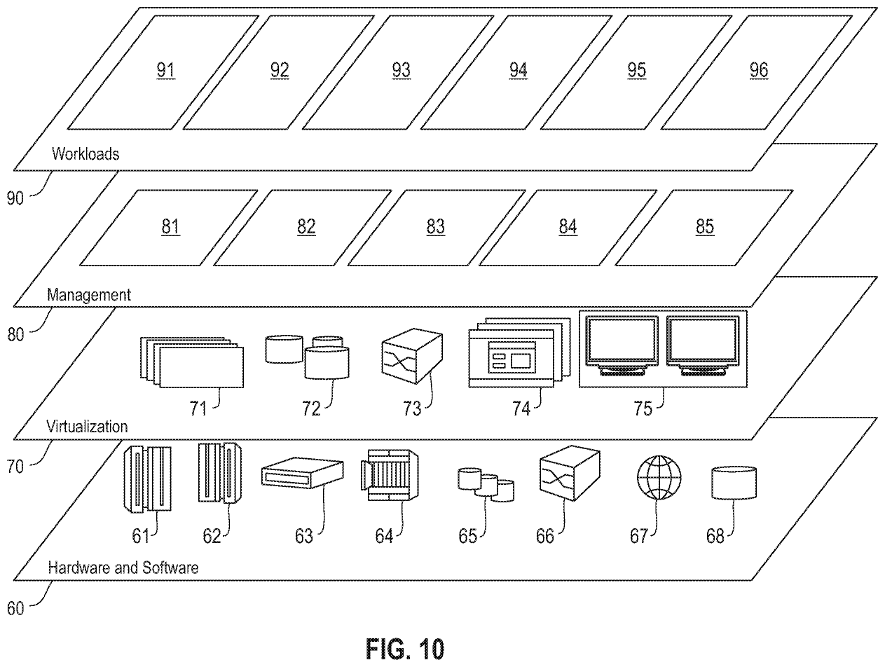

Referring now to FIG. 10, a set of functional abstraction layers provided by cloud computing environment 50 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75. In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources.

In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and collaborative enterprise determinations 96, in accordance with the one or more embodiments of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

At least one embodiment of the present invention may provide a beneficial effect such as, for example, estimating impact functions using historical data to assign weights and assist agents to learn corresponding impact functions, business decisions and weights for financial and non-financial portions of particular impacts.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
generating, for each one of multiple target entities within an enterprise, one or more impact functions pertaining to entity-specific impacts of at least one regulation on one or more impact factors;
producing weighted impact functions by applying, to the generated impact functions, weights determined by the multiple target entities;
calculating a combined enterprise impact attributed to the at least one regulation by combining the weighted impact functions via one or more algorithms;
determining a single collaborative enterprise policy for complying with the at least one regulation based at least in part on the combined enterprise impact; and
outputting the collaborative enterprise policy to the multiple target entities within the enterprise;
wherein the method is carried out by at least one computing device.

2. The computer-implemented method of claim 1, wherein said generating the impact functions comprises iteratively estimating one or more impact functions using one or more Gibbs random fields.

3. The computer-implemented method of claim 1, wherein said generating the impact functions comprises implementing one or more natural language processing techniques.

4. The computer-implemented method of claim 1, wherein said generating the impact functions comprises implementing one or more support vector machines.

5. The computer-implemented method of claim 1, wherein said generating the impact functions comprises implementing one or more naïve Bayes classifiers.

6. The computer-implemented method of claim 1, wherein said generating the impact functions comprises implementing one or more deep learning techniques.

7. The computer-implemented method of claim 1, wherein said determining a single collaborative enterprise policy comprises carrying out multiple iterations of (i) said generating, (ii) said producing, and (iii) said calculating.

8. The computer-implemented method of claim 1, wherein the weights are determined by the multiple target entities via iteratively estimating one or more weights using one or more Gibbs random fields.

9. The computer-implemented method of claim 1, wherein the one or more impact factors comprise one or more financial impact factors.

10. The computer-implemented method of claim 1, wherein the one or more impact factors comprise one or more non-financial impact factors.

11. The computer-implemented method of claim 1, wherein the multiple target entities comprise two or more of (i) one or more audit-related entities, (ii) one or more finance-related entities, (iii) one or more operations-related entities, (iv) one or more security-related entities, (v) one or more legal-related entities, and (vi) one or more sales and marketing-related entities.

12. A computer program product comprising a computer readable storage medium having program instructions embodied therewith, the program instructions executable by a computing device to cause the computing device to:
generate, for each one of multiple target entities within an enterprise, one or more impact functions pertaining to entity-specific impacts of at least one regulation on one or more impact factors;
produce weighted impact functions by applying, to the generated impact functions, weights determined by the multiple target entities;
calculate a combined enterprise impact attributed to the at least one regulation by combining the weighted impact functions via one or more algorithms;
determine a single collaborative enterprise policy for complying with the at least one regulation based at least in part on the combined enterprise impact; and
output the collaborative enterprise policy to the multiple target entities within the enterprise.

13. The computer program product of claim 12, wherein said generating the impact functions comprises iteratively estimating one or more impact functions using one or more Gibbs random fields.

14. The computer program product of claim 12, wherein said generating the impact functions comprises implementing one or more natural language processing techniques.

15. The computer program product of claim 12, wherein said generating the impact functions comprises implementing one or more support vector machines.

16. The computer program product of claim 12, wherein said generating the impact functions comprises implementing one or more naïve Bayes classifiers.

17. The computer program product of claim 12, wherein said generating the impact functions comprises implementing one or more deep learning techniques.

18. The computer program product of claim 12, wherein said determining a single collaborative enterprise policy comprises carrying out multiple iterations of (i) said generating, (ii) said producing, and (iii) said calculating.

19. A system comprising:
a memory; and
at least one processor operably coupled to the memory and configured for:
generating, for each one of multiple target entities within an enterprise, one or more impact functions pertaining to entity-specific impacts of at least one regulation on one or more impact factors;
producing weighted impact functions by applying, to the generated impact functions, weights determined by the multiple target entities;
calculating a combined enterprise impact attributed to the at least one regulation by combining the weighted impact functions via one or more algorithms;
determining a single collaborative enterprise policy for complying with the at least one regulation based at least in part on the combined enterprise impact; and
outputting the collaborative enterprise policy to the multiple target entities within the enterprise.

20. A computer-implemented method comprising:
generating, for each one of multiple substantive departments within an enterprise, one or more impact functions pertaining to (i) one or more financial impact factors in connection with at least one regulation and (ii) one or more non-financial impact factors in connection with the at least one regulation;
producing weighted impact functions by applying, to the generated impact functions, weights determined by the multiple substantive departments within the enterprise;
calculating a combined enterprise impact attributed to the at least one regulation by combining the weighted impact functions via implementing one or more neural models;
determining a single collaborative enterprise policy for complying with the at least one regulation based at least in part on the combined enterprise impact;
outputting the collaborative enterprise policy to the multiple substantive departments within the enterprise; and
updating the weighted impact functions based at least in part on feedback related to the collaborative enterprise policy from one or more of the multiple substantive departments within the enterprise;
wherein the method is carried out by at least one computing device.
